(19) United States
(12) Patent Application Publication
(10) Pub. No.: US 2002/0048073 A1
(43) Pub. Date: Apr. 25, 2002

(54) Variable optical attenuator and system

(76) Inventors: Naoki Kawawada, Chiba-shi (JP); Masahiro Nakajima, Chiba-shi (JP); Akihiro Iino, Chiba-shi (JP)

Correspondence Address: ADAMS & WILKS, 31st FLOOR, 50 BROADWAY, NEW YORK, NY, 10004, US

(21) Appl. No.: 09/944,364

(22) Filed: Aug. 31, 2001

(30) Foreign Application Priority Data
Oct. 2, 2000 (JP) 2000-301688

(51) Int. Cl. G02B 26/02

(52) U.S. Cl. 359/230

(57) ABSTRACT

Variable optical attenuator and system are offered that permit fine adjustment of the amount of shielding, eliminate variations in the amount of shielding, and facilitate positioning. The variable optical attenuator is mounted in a region of a collimated beam formed between a pair of opposite optical systems. The attenuator continuously attenuates the collimated beam. The attenuator comprises a shielding plate and a pushing means for pushing against one face of the shielding plate, placing it in position, and producing flexural deformation. The shielding plate has a fixed base-end portion and a front-end portion that is so held as to be a free end. At least the base-end portion consists of a leaf spring. The amount by which the collimated beam is shielded by the front end is varied according to the amount of flexural deformation of the shielding plate.

### BACKGROUND OF THE INVENTION

1. Field of the Invention

The present invention relates to a variable optical attenuator and system for continuously attenuating a collimated beam formed between a pair of optical systems.

2. Description of the Related Art

In optical communications, a variable optical attenuator for appropriately adjusting the light intensity is necessary to secure transmission quality.

In recent years, wavelength-multiplexed communications and parallel multichannel communications have spread. In these wavelength-multiplexed communications and parallel multichannel communications, there is a demand for miniaturization to make uniform the light intensities of plural channel signals. Also, there is a demand for fine adjustment for setting and adjusting the amount of variable adjustment of the amount of attenuation to 0.02-0.01 dB.

One proposed structure of these variable optical attenuators uses filters to attenuate light. Another proposed structure adjusts the aperture of a shutter to attenuate light.

In the former structure, platelike filters having different light absorption coefficients are used to vary the amount of absorption of light. Thus, the transmitted light is attenuated.

However, in the variable optical attenuator using such filters, it is difficult to vary the amount of attenuation of light continuously. Also, the attenuator has the problems that it is bulky and suffers from a large amount of insertion loss.

On the other hand, in the latter structure, the amount of light cut off is continuously varied by stopping down the shutter, as described in Japanese patent laid-open No. 54651/1979. In this way, the light intensity is appropriately adjusted.

A variable optical attenuator relying on stopping down of the shutter is now described.

FIG. 11 is a plan view of the related art variable optical attenuator.

As shown, the variable optical attenuator has ferrules 12 at the front ends of a pair of optical fibers 11. Optical systems 13 are mounted opposite to the front ends of the ferrules 12, respectively. There is a region of a collimated beam 14 between these optical systems 13. A pair of shielding plates 131, 132 assuming a platelike form and adjusting means 140 are mounted in this region. The adjusting means moves along the faces of the shielding plates 131 and 132 to adjust the amount by which the collimated beam 14 is shielded.

The pair of shielding plates 131 and 132 have their front ends overlapping each other. V-shaped cutout portions 131a and 132a are formed in the overlapped front ends in an opposite relation to each other. A rhombic opening portion 133 is formed by causing the cutout portions 131a and 132a in the pair of shielding plates 131 and 132 to register with each other. The amount by which the collimated beam 14 is shielded is adjusted by adjusting the size of the rhombic opening portion 133 continuously.

The surfaces of the shielding plates 131 and 132 (at least the vicinities of the opening portion 133) are treated to absorb the shielded light.

The size of the opening portion 133 formed by the pair of shielding plates 131 and 132 described above is adjusted by the adjusting means 140. As the adjusting means 140, there are mounted flange portions 131b at both lateral sides of one shielding plate 131 and screw portions 141 tightened against the body of the apparatus 110 to hold one shielding plate 131. The shielding plate 131 is moved along the surface by rotating the screw portions 141. Thus, the size of the opening portion 133 is varied, and the amount by which the collimated beam 14 is shielded is adjusted.

In the case of the variable optical attenuator using stopping down of the shielding plates as described above, if the optical fiber used in the optical systems is a single-mode fiber, the collimated light beam has a diameter of 0.6 to 1.0 mm, which may vary slightly depending on the lens diameter. Since the size of the opening portion formed by the shielding plates is about 1 mm, it is very difficult to align the opening of the shielding plates with the collimated beam. Hence, it takes a long time to perform the positioning operation.

In wavelength-multiplexed communications, the amount of attenuation is required to be adjustable by a quite small amount of 0.02 to 0.01 dB. In the variable optical attenuator using stopping down of the shielding plate, the size of the opening is only about 1 mm. Furthermore, the screw portions for varying the degree of stopping down have rattling such as backlash. This results in great variations in the amount of attenuation. In addition, the screw portions are formed at a pitch of 0.3 to 1.0 mm. Consequently, it is difficult to finely adjust the amount of shielding.

### SUMMARY OF THE INVENTION

In view of the circumstances described thus far, it is an object of the present invention to provide a variable optical attenuator and system permitting the amount of shielding to be adjusted finely, eliminating variations in the amount of shielding, and facilitating alignment.

A first embodiment of the present invention that achieves the above-described object is a variable optical attenuator mounted in a collimated beam region formed between a pair of opposite optical systems and acting to continuously attenuate the collimated beam, the variable optical attenuator being characterized that it comprises a shielding plate and a pushing means. The shielding plate has a fixed base-end portion and a front-end portion that is held so as to be a free end. At least the base-end portion consists of a leaf spring. The pushing means pushes against one face of the shielding plate to place it in position and cause flexural deformation of the shielding plate. The amount by which the collimated beam is shielded with the front end of the shielding plate varies according to the amount of flexural deformation of the shielding plate.

A second embodiment of the present invention is a variable optical attenuator based on the first embodiment and further characterized in that the above-described pushing means comprises a cam and a driving motor for rotating the cam whose outer surface is in sliding contact with the shielding plate. The amount of flexural deformation of the shielding plate is varied as the cam is rotated.

A third embodiment of the present invention is a variable optical attenuator based on the second embodiment and further characterized in that the above-described cam is an eccentric cam.

A fourth embodiment of the present invention is a variable optical attenuator based on the second or third embodiment and further characterized in that either one of the shielding plate and the cam has a low frictional layer of low frictional coefficient at least in a region in sliding contact with the other.

A fifth embodiment of the present invention is a variable optical attenuator based on the fourth embodiment and further characterized in that the above-described low frictional layer is formed on the shielding plate and also on the cam.

A sixth embodiment of the present invention is a variable optical attenuator based on any one of the second through fifth embodiments and further characterized in that the above-described driving motor is a pulse motor whose rotational angle can be grasped.

A seventh embodiment of the present invention is a variable optical attenuator based on any one of the second through fifth embodiments and further characterized in that the above-described pushing means is equipped with a rotational angle-grasping means for grasping the rotational angle of the driving motor.

An eighth embodiment of the present invention is a variable optical attenuator based on the seventh embodiment and further characterized in that the above-described rotational angle-grasping means comprises an encoder mounted coaxially with the cam and an interrupter for grasping the rotational angle of the encoder.

A ninth embodiment of the present invention is a variable optical attenuator based on any one of the first through eighth embodiments and further characterized in that at least a region of the shielding plate that shields light has a low thermal expansion layer having a low coefficient of thermal expansion.

A tenth embodiment of the present invention is a variable optical attenuator based on any one of the first through ninth embodiments and further characterized in that at least a region of the cam that makes a sliding contact with the shielding plate has a low thermal expansion layer having a low coefficient of thermal expansion.

An eleventh embodiment of the present invention is a variable optical attenuator based on any one of the first through tenth embodiments and further characterized in that the shielding plate is a plate made of stainless steel.

A twelfth embodiment of the present invention is a variable optical attenuator based on any one of the first through eleventh embodiments and further characterized in that the shielding plate and the aforementioned collimated beam form an angle of about 30° therebetween.

A thirteenth embodiment of the present invention is a variable optical attenuation system comprising variable optical attenuators built in accordance with any one of the first through twelfth embodiments and mounted in positions on opposite sides of the collimated beam.

A fourteenth embodiment of the present invention is a variable optical attenuation system based on the thirteenth embodiment and further characterized in that first and second variable optical attenuators mounted in positions on the opposite sides of the collimated beam are used selectively according to the direction of the collimated beam.

In the present invention described thus far, a variable optical attenuator is formed by the shielding plate that undergoes flexural deformation and shields the collimated beam and the pushing means for pushing against the shielding plate. Therefore, the amount of shielding can be easily and reliably adjusted finely with the amount of push of the pushing means. Furthermore, if the pushing means has mechanical rattling, the repulsive force of the flexurally deformed shielding plate suppresses the rattling, thus eliminating variations in the amount of shielding. Furthermore, the shielding plate undergoes flexural deformation and thus shields the collimated beam by its front end. Therefore, if the shielding plate and the pushing means are mechanically placed in position in the collimated beam region, it is easy to place the shielding plate in the position where the plate shields the collimated beam.

### BRIEF DESCRIPTION OF THE DRAWINGS

FIG. 1 is a cross-sectional view of a variable optical attenuation system incorporating a variable optical attenuator in accordance with Embodiment 1 of the present invention;

FIG. 2 is a plan view of main portions of the variable optical attenuator in accordance with Embodiment 1 of the invention;

FIG. 3 is a plan view showing the manner in which a collimated beam is shielded by the variable optical attenuator in accordance with Embodiment 1 of the invention;

FIG. 4 is a plan view showing another variable optical attenuator in accordance with Embodiment 1 of the invention;

FIG. 5 is a plan view of a variable optical attenuator in accordance with Embodiment 2 of the invention;

FIG. 6 is a plan view of a variable optical attenuator in accordance with Embodiment 3 of the invention;

FIG. 7 is a plan view illustrating the state in which a collimated beam is shielded by a shielding plate in accordance with other embodiment of the invention;

FIG. 8 is a plan view illustrating the state in which a collimated beam is shielded by a shielding plate in accordance with other embodiment of the invention;

FIG. 9 is a cross-sectional view of a cam in accordance with another embodiment of the invention;

FIG. 10 is a cross-sectional view of a cam and a shielding plate in accordance with a further embodiment of the invention; and

FIG. 11 is a plan view of the related art variable optical attenuator.

### DESCRIPTION OF THE PREFERRED EMBODIMENTS

Embodiment 1

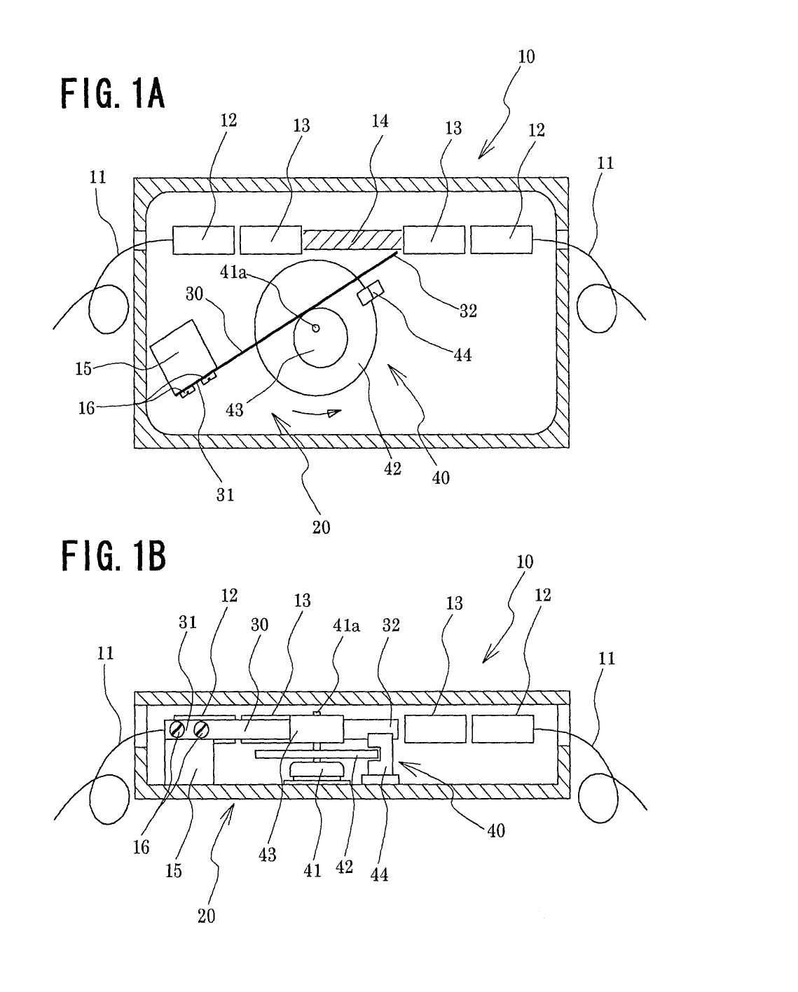

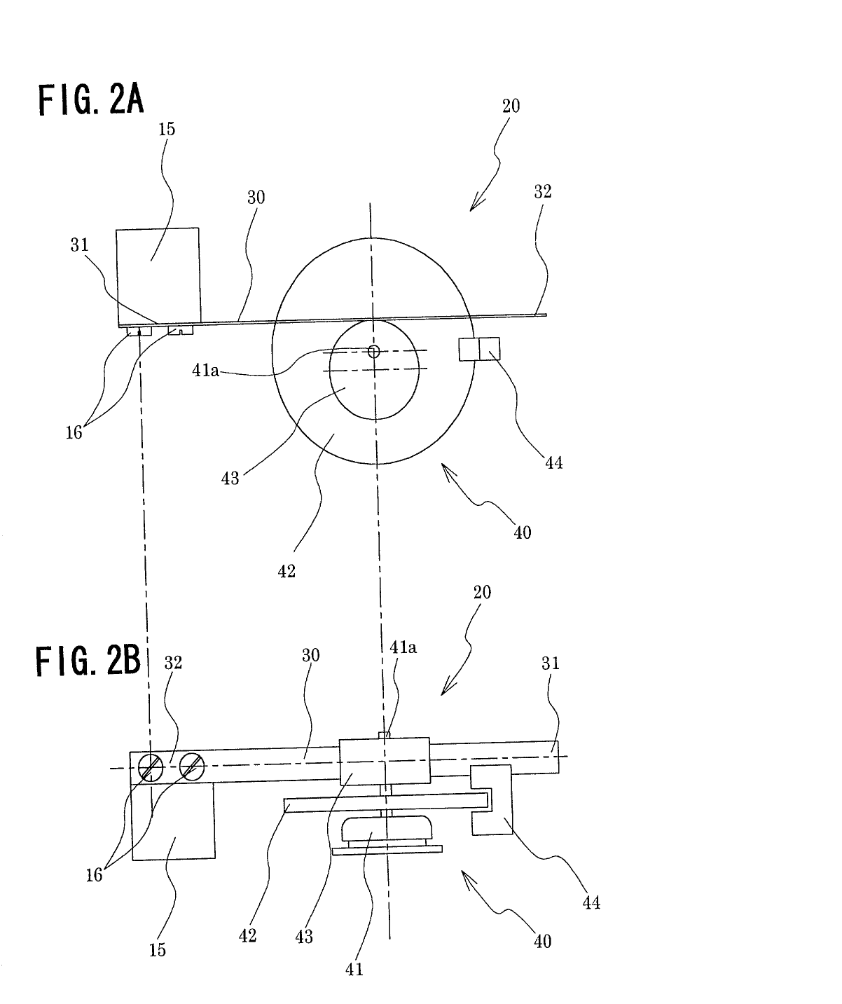

FIG. 1 is a cross-sectional view of a variable optical attenuation system incorporating a variable optical attenuator in accordance with Embodiment 1 of the present invention. FIG. 2 is a plan view of the variable optical attenuator in accordance with Embodiment 1.

As shown, the variable optical attenuation system, 10, in accordance with the present embodiment comprises a pair of optical fibers 11, ferrules 12 mounted at the front ends of the optical fibers, a pair of optical systems 13 for shaping light emitted from the front ends of the ferrules 12 into a collimated beam 14, and a variable optical attenuator 20 for continuously attenuating the collimated beam 14 formed between the pair of optical systems.

In the present embodiment, the pair of optical systems 13 are mounted at the sides of the front ends of the ferrules 12 connected with the front ends of the pair of optical fibers 11, respectively. Light emitted from the front end of one ferrule 12 is shaped into the collimated beam 14, which is then converged into the other ferrule 12. For example, the optical systems are made up of aspherical lenses, SELFOC lenses, and so on. In the present embodiment, light made to enter from the optical fiber 11 at the left as viewed in the figure is caused to exit from the right optical fiber 11 via the pair of optical systems 13.

The collimated beam 14 formed in this way is 0.6 to 1.0 mm in diameter in this embodiment.

On the other hand, the variable optical attenuator 20 has a shielding plate 30 for shielding the collimated beam 14 formed between the optical systems 13 and a pushing means 40 for pushing the shielding plate 30 to cause flexural deformation.

The shielding plate 30 is a leaf spring whose base-end portion 31 is fixedly mounted to the variable optical attenuation system 10. Its front end 32 is a free end. As it undergoes flexural deformation, it can move into the region of the collimated beam 14 in the optical systems 13.

In particular, the base-end portion 31 of the shielding plate 30 is fixed to a stationary portion 15 mounted in the variable optical attenuation system 10 by a pair of screw portions 16 such that the angle formed between this base-end portion 31 and the collimated beam 14 is about 30°. The front end 32 of the shielding plate 30 is adjacent to the region of the collimated beam 14. This shielding plate 30 is made of a stainless steel plate having a thickness of 0.3 to 0.5 mm in the present embodiment.

In the present embodiment, the shielding plate 30 is made of a leaf spring of stainless steel. However, it is only necessary that at least the base-end portion 31 be made of a leaf spring, because the shielding plate 30 is only required to undergo flexural deformation.

When the shielding plate 30 shields the collimated beam 14, the region shielding the collimated beam 14 (on the side of the front end 32 in the present embodiment) is irradiated with the collimated beam 14 and thus is thermally expanded. There is a danger that deformation due to the thermal expansion introduces an error in the amount by which the collimated beam 14 is shielded. Therefore, at least the region of the shielding plate 30 on the side of the front end 32 that shields the collimated beam 14 is made of a material having a low coefficient of thermal expansion, e.g., ceramics.

Furthermore, in the present embodiment, the shielding plate 30 is so mounted that the angle with respect to the collimated beam 14 is about 30°. If the angle formed between the shielding plate 30 and the collimated beam 14 is set close to right angles, there is a danger that the collimated beam 14 shielded by the shielding plate 30 might be reflected to the shielding plate 30 and return to the optical systems 13. Moreover, if the shielding plate 30 is placed nearly vertically, it is difficult to finely adjust the amount by which the beam is shielded with the pushing means 40 as described later. For this reason, the shielding plate 30 is preferably so disposed that the angle with respect to the collimated beam 14 is a relatively small angle. Preferably, this angle is about 30°. The surface of the shielding plate 30 may be so processed as to absorb light to prevent the shielded collimated beam 14 from being reflected.

On the other hand, the pushing means 40 has a driving motor 41, an encoder 42, a cam 43, and an interrupter 44.

An ultrasonic motor is used as the driving motor 41 in the present embodiment. The encoder 42 and the cam 43 are held to the rotating shaft 41a of this driving motor 41.

The cam 43 is an eccentric cam in the present embodiment. The amount of eccentricity is set to 0.5 mm, for the following reasons. Where the cam 43 is made of an eccentric cam, the size needs to be minimized. The amount of eccentricity must be large enough to prevent the fabrication accuracy from being deteriorated.

The outer surface of the cam 43 is so placed that it makes a sliding contact with one face of the shielding plate 30. When the cam 43 is rotated by the driving motor 41, the outer surface of the cam 43 pushes against the shielding plate 30. Since the cam 43 is an eccentric cam with an amount of eccentricity of 0.5 mm in this embodiment, the shielding plate 30 can be pressed against the other face to produce a flexural deformation of about 1.0 mm.

The cam 43 is so mounted as to make a sliding contact with the portion of the shielding plate 30 that is almost midway between the base-end portion 31 and the front end 32 in this embodiment. If this central portion of the shielding plate 30 is pushed about 1.0 mm by rotation of the cam 43, the front end 32 of the shielding plate 30 moves about 2.0 mm toward the other face.

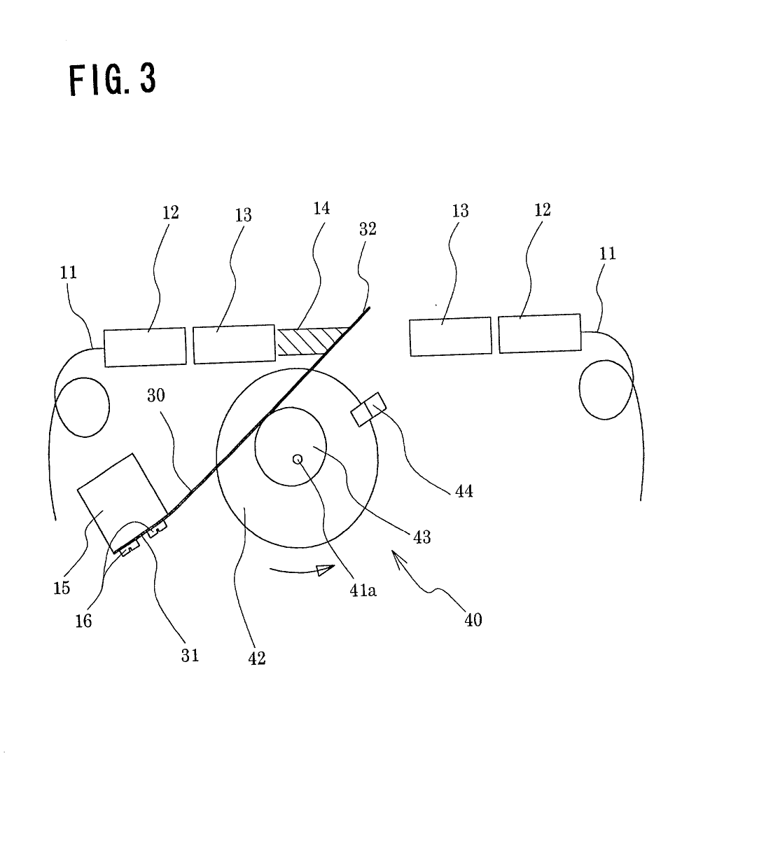

Therefore, as shown in FIG. 3, the shielding plate 30 can fully shield the collimated beam 14 by its front end 32 making use of the rotation of the cam 43. FIG. 3 is a plan view in which the collimated beam is shielded by the shielding plate.

In the present embodiment, the cam 43 makes a sliding contact with a substantially central portion of the shielding plate 30. It is to be noted that no limitations are imposed on this location where a sliding contact is made. If the cam 43 is so mounted that it makes a sliding contact with a portion close to the base-end portion 31, for example, an amount of displacement of the front end 32 caused by rotation of the cam 43 is large, but blurring may occur, because the front end 32 is a free end. This may introduce an error in the amount by which the collimated beam 14 is shielded. On the other hand, if the cam 43 is so mounted that it makes a sliding contact with a portion on the side of the front end 32, blurring of the front end 32 may be prevented. However, the amount of displacement of the front end 32 caused by rotation of the cam 43 is small. Consequently, in the present embodiment, the cam 43 is set to make a sliding contact with a substantially central portion of the shielding plate 30. Blurring of the front end 32 is suppressed. The amount of displacement of the front end 32 owing to the rotation of the cam 43 is prevented from becoming too small.

The encoder 42 and the interrupter 44 measure the rotational angle of the driving motor 41, i.e., the rotational angle of the cam 43. Specifically, the encoder 42 is held to the rotating shaft 41a of the driving motor 41 together with the cam 43. Slits (not shown) (e.g., 36,000 or 72,000 slits per revolution) formed in the encoder 42 are detected by the interrupter 44 mounted to the variable optical attenuation system 10. The number of detected slits is counted. In this way, the infinitesimal rotational angle is measured. The rotational angle of the cam 43 is grasped by measuring the rotational angle of the encoder 42. The distance over which the shielding plate 30 is pushed by the cam 43 is controlled by controlling the rotational angle of the driving motor 41. Thus, the amount by which the front end 32 of the shielding plate 30 shields the collimated beam 14 is controlled.

If this cam 43 is thermally expanded due to heat with the shielding plate 30, the distance that the shielding plate 30 is pushed would contain an error. To prevent this, the cam 43 may be made of a material having a low coefficient of thermal expansion, e.g., ceramics.

In this way, in the present embodiment, the shielding plate 30 is pushed by rotation of the cam 43 consisting of an eccentric cam. The front end 32 of the shielding plate 30 shields the collimated beam 14. Therefore, the amount of flexural deformation of the shielding plate 30 is varied by controlling the rotational angle of the cam 43. In consequence, the amount by which the collimated beam 14 is shielded can be adjusted finely, easily, and continuously.

When the variable optical attenuator 20 is mounted in the variable optical attenuation system 10, the variable optical attenuator 20 can be mounted by mechanically positioning it in the region of the collimated beam 14 within the optical systems 13. Therefore, if the light has an invisible wavelength (e.g., light having a wavelength of 1550 nm), the attenuator can be easily and reliably placed in position.

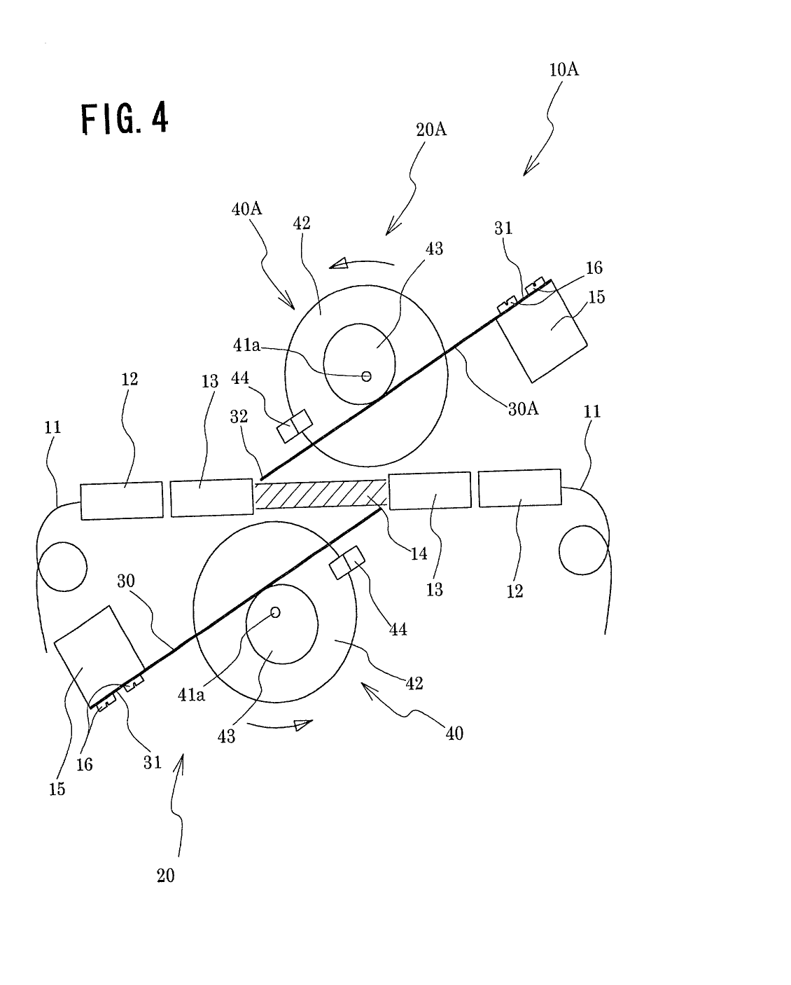

In the variable optical attenuation system 10 in accordance with the present embodiment, light entered from the optical fiber 11 at the left as viewed in the figure is shaped into the collimated beam 14 by the optical systems 13. This collimated beam 14 is made to exit from the optical fiber 11 at the right as viewed in the figure. The invention is not limited to this configuration. For example, to permit the light to enter and exit from either optical fiber without determining the direction of the collimated light beam, two variable optical attenuators 20 and 20A may be placed in positions on the opposite sides of the collimated beam 14. This example is shown in FIG. 4, which is a plan view of main portions of the variable optical attenuation system.

As shown, the variable optical attenuation system, 10A, comprises ferrules 12 mounted at the front ends of a pair of optical fibers 11, a pair of optical systems 13 for forming a collimated beam 14, the variable optical attenuator 20, and the variable optical attenuator 20A mounted in the region that is on the opposite side of the collimated beam 14 from the variable optical attenuator 20.

The variable optical attenuator 20A is fitted with a shielding plate 30A and a pushing means 40A. The shielding plate 30A is mounted at about 30° to the collimated beam 14 on the opposite side of the shielding plate 30.

This variable optical attenuator 20A is used where light is made to enter from the optical fiber 11 at the right as viewed in the figure and light is made to exit from the optical fiber 11 at the left as viewed in the figure.

The pushing means 40A has a driving motor 41, an encoder 42, a cam 43, and an interrupter 44 in the same way as the pushing means 40. The cam 43 of the pushing means 40A pushes against the shielding plate 30A, thus resulting in flexural deformation.

Where the variable optical attenuator 10A is designed to have the variable optical attenuators 20 and 20A as described above, no restrictions are placed on the direction of light passing into and out of the optical fibers 11, i.e., the sense of the collimated beam 14. Therefore, it is unlikely that the user mistakes the directions of entrance and departure. Also, it is not cumbersome to mount the devices.

Furthermore, the variable optical attenuation system may be so set up that the shielding plates 30 and 30A of the variable optical attenuators 20 and 20A, respectively, are arranged at such angles that the same sense is created. In this case, the two shielding plates are used to shield one-way collimated beam 14. Hence, the collimated beam can be shielded from both sides uniformly.

Embodiment 2

In Embodiment 1 described above, an ultrasonic motor is used as the driving motor 41 of the pushing means 40. In Embodiment 2, a pulse motor is used as the driving motor.

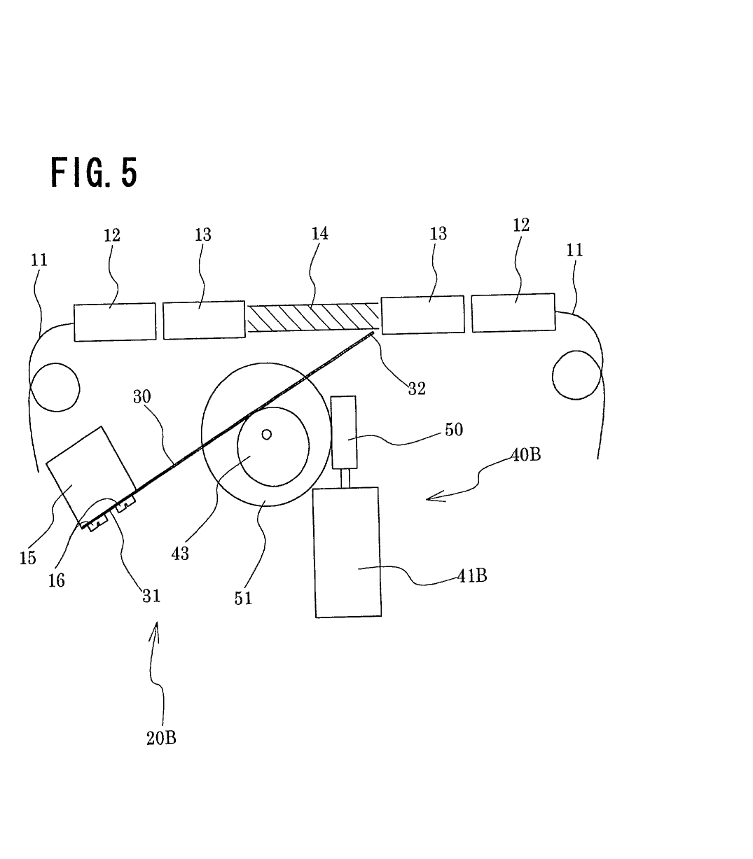

FIG. 5 is a plan view of main portions of a variable optical attenuator in accordance with Embodiment 2 of the present invention.

As shown, the variable optical attenuator 20B in accordance with the present embodiment is similar to that of Embodiment 1 described above except that a pulse motor is used as the driving motor 41B of the pushing means 40B and that the driving force of this pulse motor is transmitted to the cam 43 via a worm gear 50 and via a wheel gear 51.

Where a pulse motor is used as the driving motor 41B, the rotational speed of the pulse motor can be grasped by counting the pulses. Therefore, it is not necessary to provide any encoder.

Where a pulse motor is used as the driving motor 41B and the drive of the driving motor 41B is transmitted to the cam 43 via the worm gear 50 and wheel gear 51 in this way, if the cam 43 pushes against the shielding plate 30 to cause flexural deformation, the repulsive force of the shielding plate 30 can prevent generation of mechanical rattling such as backlash in the worm gear 50 and the wheel gear 51.

Furthermore, the amount of flexural deformation of the shielding plate 30 can be controlled by controlling the rotational angle of the cam 43 by means of the driving motor 41B. The amount by which the collimated beam 14 is shielded can be easily controlled with the shielding plate 30.

Embodiment 3

In Embodiment 1 described above, an ultrasonic motor is employed as the driving motor 41 of the pushing means 40. In Embodiment 3, a DC motor is used as the driving motor.

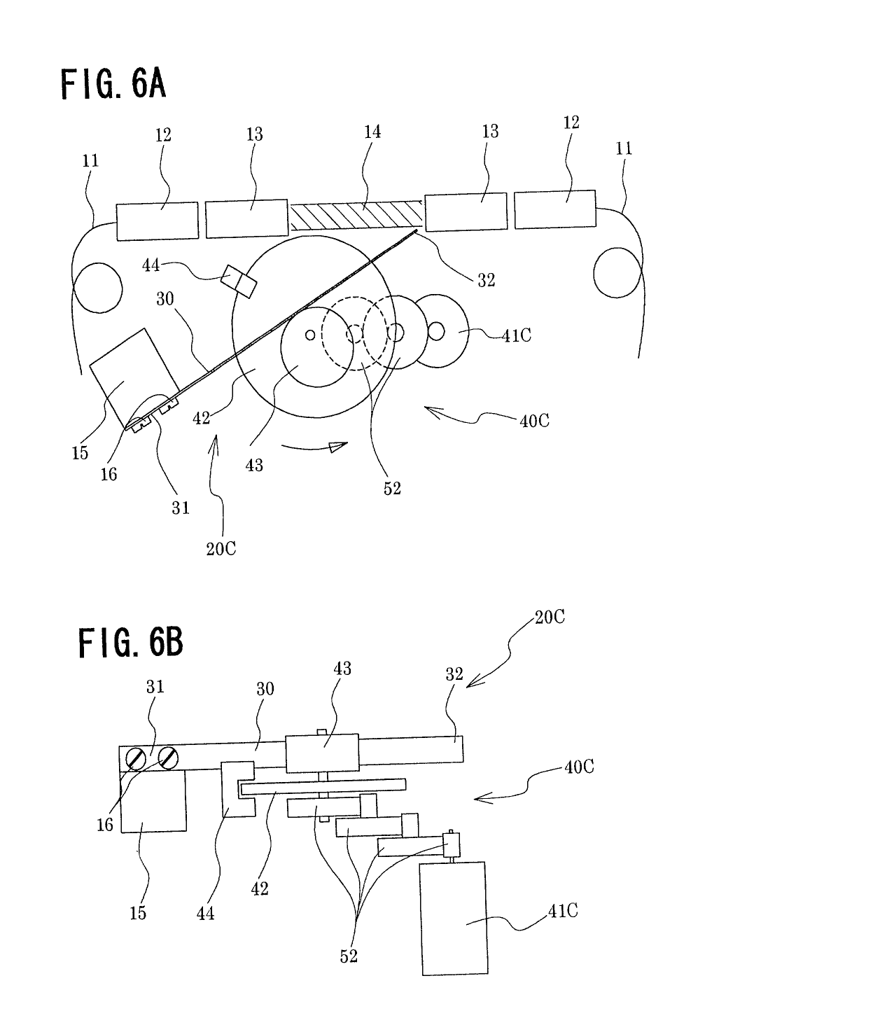

FIG. 6 is a plan view of main portions of a variable optical attenuator in accordance with Embodiment 3 of the present invention.

As shown, the pushing means 40C of the variable optical attenuator 20C in accordance with the present embodiment is similar to that of Embodiment 1 described above except that a DC motor is used as the driving motor 41C and that the drive of this DC motor is transmitted to the cam 43 by means of plural gears 52.

Where a DC motor is used as the driving motor 41C in this way, the encoder 42 is still necessary. However, when the cam 43 is pushed against the shielding plate 30 to thereby produce flexural deformation, the repulsive force of the shielding plate 30 can prevent generation of mechanical rattling such as backlash in the plural gears 52.

In addition, the shielding plate 30 can easily control the amount by which the collimated beam 14 is shielded, using the rotational angle of the driving motor 41C.

Other Embodiments

While Embodiments 1-3 of the present invention have been described thus far, the fundamental structure of the variable optical attenuator and system is not limited to the foregoing structure.

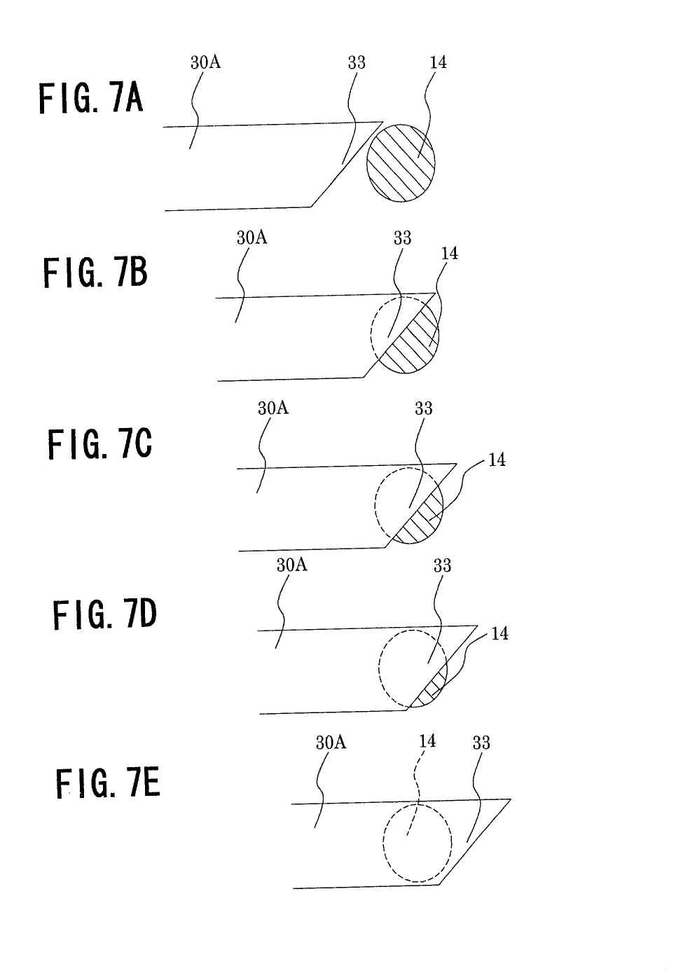

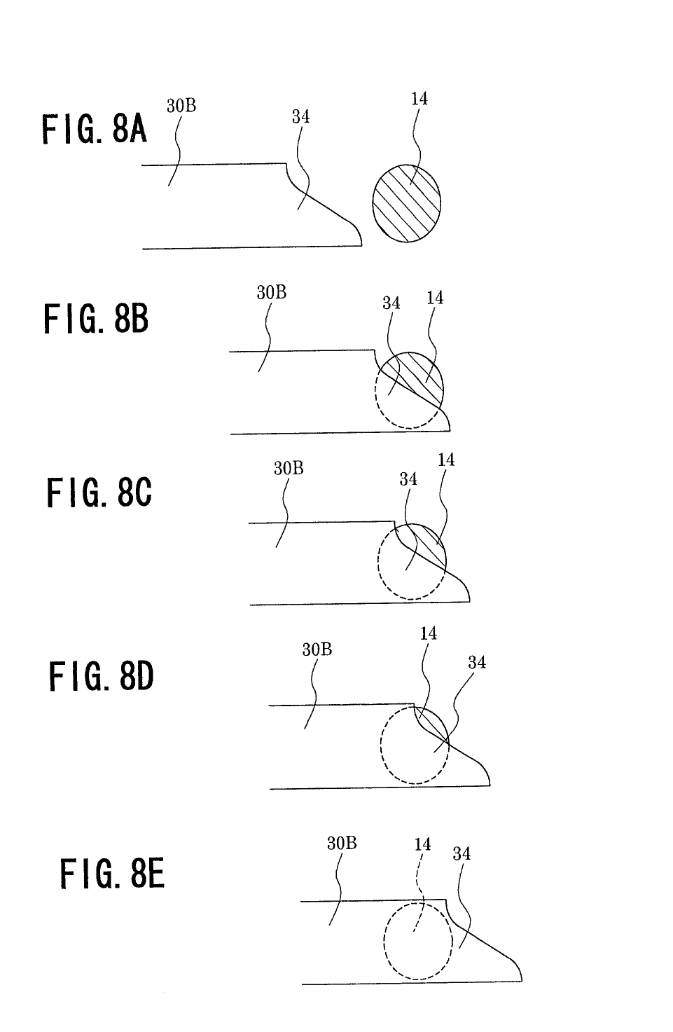

For example, in the present embodiment, the shielding plate 30 is a leaf spring that takes a rectangular form. Since the amount of light increases with approaching the center of the collimated beam 14, the front end of the shielding plate may be shaped as shown in FIGS. 7 and 8 such that the area of the plate shielding the collimated beam increases when the front end is displaced because of flexural deformation of the shielding plate. FIGS. 7 and 8 are plan views in which a collimated beam is shielded by shielding plates in accordance with other embodiments.

As shown in FIG. 7, the front end 33 of the shielding plate 30A is at an angle to the optical system 13 such that the area of the plate shielding the collimated beam 14 increases with displacement of the front end 33 when the shielding plate 30A undergoes flexural deformation relative to the collimated beam 14.

Since the front end 33 of the shielding plate 30A is shaped in this manner, if the shielding plate 30A is pushed by the pushing means 40 to cause flexural deformation, the area of the plate shielding the collimated beam 14 increases with displacement of the front end 33 of the shielding plate 30A. Therefore, it is easy to finely adjust the amount of shielding.

As shown in FIG. 8, the shape of the front end 34 of the shielding plate 30B may be a smooth curved line relative to the collimated beam 14.

Since the front end 34 of the shielding plate 30B is shaped in this way, when the shielding plate 30B shields the collimated beam 14 as a result of displacement of the front end 34 caused by flexural deformation of the shielding plate 30B, the area of the plate shielding the vicinities of the central portion where the amount of light of the collimated beam 14 is large does not vary greatly with displacement of the front end 34 as shown in FIGS. 8(b) and 8(c). Therefore, the amount by which the collimated beam 14 is shielded can be varied at a uniform rate as the shielding plate 30B undergoes flexural deformation.

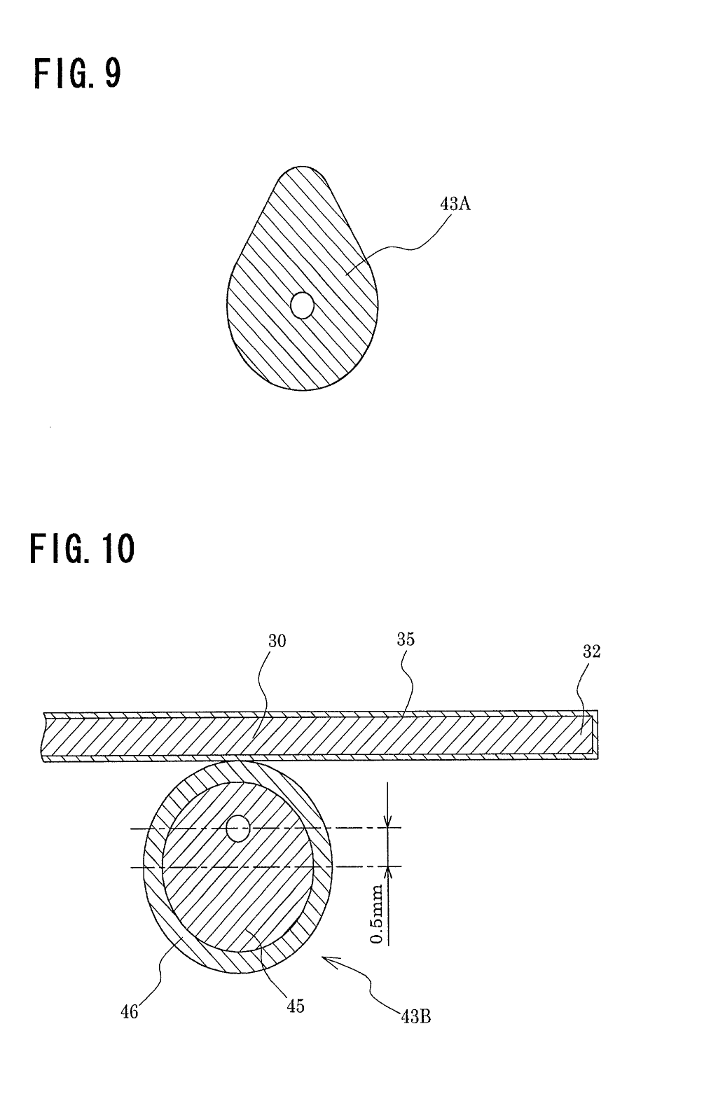

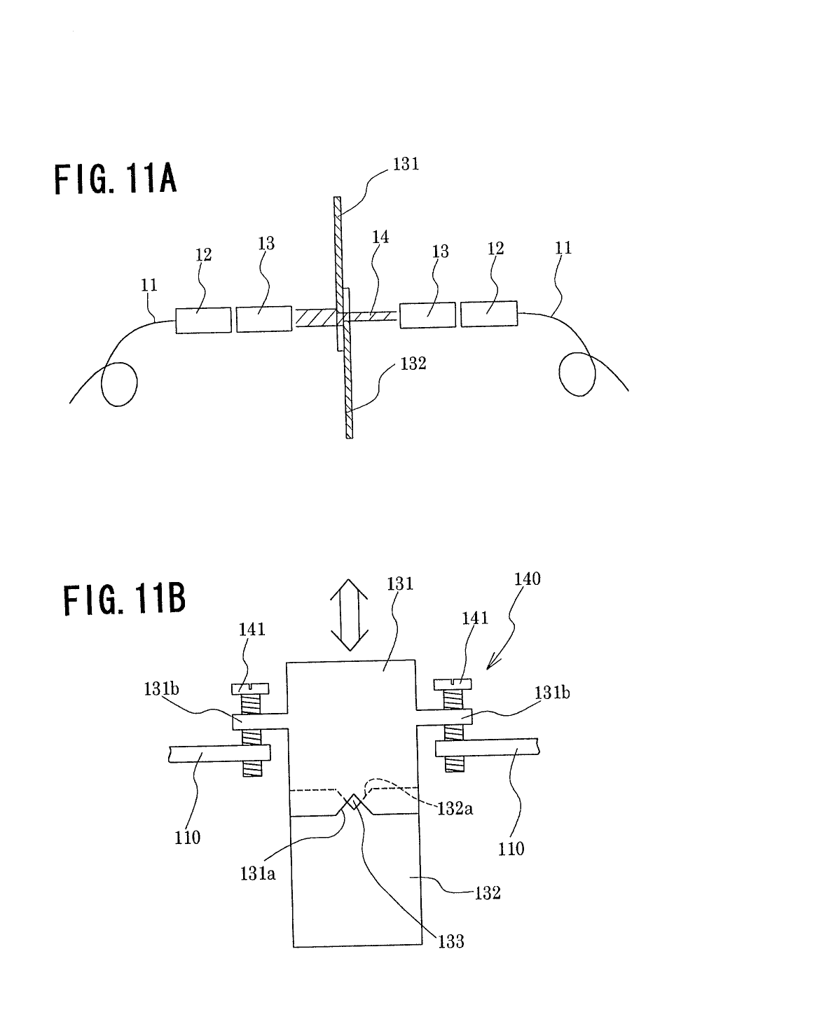

In Embodiments 1-3 described above, the driving motors 41, 41B, 41C and the cam 43 are provided as pushing means 40, 40A-40C for pushing against the shielding plate 30. This can accomplish a small-sized simple structure that undergoes accurate flexural deformation. The cam is relatively easy to fabricate, because it is a genuinely circular cam with an eccentric shaft. As shown in FIG. 9, the amount of flexural deformation may be varied using a specially shaped cam 43A having a nonuniform thickness around the outer fringes of the shaft. FIG. 9 is a cross-sectional view of the specially shaped cam.

In addition, the shielding plate 30 may be pushed, for example, by a linear actuator (piezoelectric type), a screw and a motor, a rack and a pinion, or the like. In any case, if the shielding plate can be pushed by the pushing means and undergo flexural deformation, effects similar to those derived by Embodiments 1-3 described above can be obtained.

Furthermore, a low frictional layer having a low frictional coefficient may be formed on at least one of the shielding plate 30 and the cam 43 or on those regions of both which make sliding contact with each other. The low frictional layer may be a resin such as polyacetal. The surface may be coated with molybdenum or the like.

An example in which a low frictional layer is formed on both shielding plate 30 and cam 43 is shown in FIG. 10, which is a cross-sectional view of the shielding plate and cam.

As shown in FIG. 10, the cam 43B comprises a metal layer 45 having a central metal portion and a low frictional layer 46 on the outer side. The low frictional layer is made of a resin such as polyacetal. That is, the cam has a double layer structure.

A low frictional layer 35 formed by coating the surface with molybdenum or the like is formed on the surface of the shielding plate 30.

By forming the low frictional layers 46 and 35 on the cam 43B and the shielding plate 30 in this way, the frictional resistance on sliding contact is reduced. This makes it easy to produce flexural deformation of the shielding plate 30 by rotating the cam 43B.

The present invention provides a variable optical attenuator made up of a shielding plate undergoing flexural deformation and shielding a collimated beam and a pushing means for pushing against the shielding plate. Therefore, the amount of shielding can be finely adjusted easily and reliably with the amount of push of the pushing means. Furthermore, if the pushing means has mechanical rattling, repulsive force created by flexural deformation of the shielding plate suppresses the rattling, thus eliminating variations in the amount of shielding. In addition, the shielding plate undergoes flexural deformation and thus shields the collimated beam by its front end. Therefore, if the shielding plate and pushing means are mechanically placed in position in the region of the collimated beam, it is easy to place the shielding plate in position for shielding the collimated beam.

What is claimed is:

1. An optical attenuator comprising:
a shielding plate having a fixed base-end portion and a front-end portion to be a free end, at least the base-end portion consisting of a leaf spring; and
a pushing means for pushing against one face of the shielding plate, placing the shielding plate in position, and producing flexural deformation of the shielding plate;
wherein the amount by which the front end of the shielding plate shields the collimated beam is varied according to the amount of flexural deformation of the shielding plate.

2. The optical attenuator of claim 1, wherein the pushing means comprises a cam whose outer surface makes a sliding contact with the shielding plate and a driving motor for rotating the cam, and wherein the amount of flexural deformation of the shielding plate varies with rotation of the cam.

3. The optical attenuator of claim 2, wherein the cam is an eccentric cam.

4. The optical attenuator of claim 2, wherein a low frictional layer having a low frictional coefficient is formed on at least one of the shielding plate and the cam at least on a region that makes a sliding contact with the other.

5. The optical attenuator of claim 4, wherein the low frictional layer is formed on both of the shielding plate and the cam.

6. The optical attenuator of any claim 2, wherein the driving motor is a pulse motor whose rotational angle can be grasped.

7. The optical attenuator of claim 2, wherein the pushing means is provided with a rotational angle-grasping means for grasping the rotational angle of the driving motor.

8. The optical attenuator of claim 7, wherein the rotational angle-grasping means comprises an encoder mounted coaxially with the cam and an interrupter for grasping the rotational angle of the encoder.

9. The optical attenuator of claim 1, wherein at least a region of the shielding plate that shields light has a low thermal expansion layer having a small coefficient of thermal expansion.

10. The optical attenuator of claim 1, wherein at least a region of the cam that makes a sliding contact with the shielding plate has a low thermal expansion layer having a small coefficient of thermal expansion.

11. The optical attenuator of claim 1, wherein the shielding plate is a plate of stainless steel.

12. The optical attenuator of claim 1, wherein the shielding plate and the collimated beam form an angle of about 30° therebetween.

13. An optical attenuation system comprising optical attenuator of claim 1, the optical variable attenuators being mounted in positions on opposite sides of the collimated beam.

14. The optical attenuation system of claim 13, wherein first and second variable optical attenuators mounted in positions on the opposite sides of the collimated beam are used selectively according to the direction of light of the collimated beam.
